(19) United States
(12) Patent Application Publication
(10) Pub. No.: US 2022/0114249 A1
(43) Pub. Date: Apr. 14, 2022

(54) SYSTEMS AND METHODS FOR SECURE AND FAST MACHINE LEARNING INFERENCE IN A TRUSTED EXECUTION ENVIRONMENT

(71) Applicants: Constantine GRANCHAROV, Waterloo (CA); Denis REMEZOV, Waterloo (CA); Nikolay GIGOV, Waterloo (CA)

(72) Inventors: Constantine GRANCHAROV, Waterloo (CA); Denis REMEZOV, Waterloo (CA); Nikolay GIGOV, Waterloo (CA)

(73) Assignee: HUAWEI TECHNOLOGIES CO., LTD., Shenzhen (CN)

(21) Appl. No.: 17/066,550

(22) Filed: Oct. 9, 2020

(51) Int. Cl. G06F 21/44; G06N 20/00; G06F 21/53; G06F 21/12; G06F 21/60; G06F 21/64; G06F 21/62

(52) U.S. Cl. CPC G06F 21/44; G06N 20/00; G06F 21/53; G06F 2221/0751; G06F 21/602; G06F 21/64; G06F 21/6245; G06F 21/12

(57) ABSTRACT

A method for executing a machine learning (ML) application in a computing environment includes receiving a secret from a trusted execution environment (TEE) of a user computing device into a TEE of a server. The user computing device is authenticated by an identity and access management service. The TEE validates the secret against a time-limited token. The method further receives from a TEE of a model release tool a model encryption key bound to the ML application. The method receives into the TEE of the server, an ML model of the ML applications encrypted with the MEK. The method decrypts using the MEK the ML model. The method receives into the TEE of the server the ML application and a descriptor of the ML application encrypted by a cryptographic key derived from the secret. The method executes the ML application using the ML model and the descriptor.

### FIELD OF THE INVENTION

This invention pertains generally to the field of secure execution of computer programs in a cloud computing environment and in particular, to an apparatus and a method for the execution of Artificial Intelligence/Machine Learning (AI/ML) models using third party cloud computing infrastructure.

### BACKGROUND OF THE INVENTION

Machine Learning (ML) models are the basis or at least one of the cornerstones upon which many AI/ML-centric companies are built. ML models can embody significant portions of the total intellectual property (IP) of these companies and details of ML models must be closely guarded for the AWL company to remain competitive.

ML models require large quantities of data, some of which may contain personally identifiable information (PII) of data owners. This PII may include information such as names, addresses, locations, biometric information, financial information, medical history. The nature of the data processed by these ML models combined with legal compliance requirements in various countries make safeguarding PII data a priority for data owner as well as AI/ML companies in in order to preserve and protect user privacy and security. Data leaks or losses can severely impact the reputation and future prospects of a company, so data protection is of utmost concern to most AWL companies.

ML applications require significant computing resources with which to execute ML models, and many small to midsize AI/ML companies opt to rent computing resources from cloud computing (cloud) providers rather than build their own data centers as a means to reduce hardware and operating costs. Examples of cloud providers include: Amazon's AWS, Google's Google Cloud, and Microsoft's Azure to name a few. As part of operating in cloud datacenters, AWL companies are forced to grant cloud providers a certain level of trust in that they will act in good faith when it comes to the security and management of the computing resources they rent. In other words, these AI/ML companies are forced to trust that cloud providers will not access data or other sensitive secrets on the cloud infrastructure that runs their applications. This trust is mainly enforced through legal means as there are few physical or technical means for enforcement. A malicious employee working at these cloud providers can still decide to use their access privileges to infiltrate the databases or physical machines and cause irreparable damage to one of these AI/ML companies by leaking or stealing proprietary or sensitive data or IP.

There exists a need to better safeguard data owner's sensitive data and AI/ML companies model IP such that even malicious insiders are not able to circumvent security mechanisms in place. There is a further need to allow an AI/ML company to retain control over their ML model and data even when running in an environment that is not their own. There is also a need to enable data owners to protect their data from the AI/ML company itself.

While there are many individual technologies that solve specific security challenges in the scenario described above, there is no one comprehensive technology or framework able to provide an all-encompassing solution to the problem above. The aforementioned technologies are either too low-level or singular in purpose to solve the problem that the Invention described in this document attempts to solve. As a result, those technologies may be used in the implementation of specific functions in the overall Invention, but complete solution with its components, processes, and protocols is unique.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Embodiments of the invention provide methods, apparatus, and systems to allow for the parties of AWL applications to preserve the security and confidentiality of their IP (models, engines, and data) when executing in a potentially non-secure remote server environment. The IP is provisioned and executed in a Trusted Execution Environment (TEE) so that each parties IP is protected from each other as well as the operators and owners of the server environment. Transfers of sensitive or confidential information is also done over secure channels between TEEs of computing systems. In some embodiments, the server environment is a cloud computing environment.

In accordance with embodiments of the present invention, there is provided a method for executing a machine learning (ML) application in a computing environment. The method includes receiving, from a trusted execution environment (TEE) of a user computing device, into a TEE of a server, a secret, where the user computing device is authenticated by an identity and access management (IAM) service and the TEE validates the secret against a time-limited token. The method further includes receiving, from a TEE of a model release tool, into the TEE of the server, a model encryption key (MEK) bound to the ML application. By way of generalized introduction, a token or other software data may be said to be “bound” to a key when a cryptographic signature is used to associate the key with the token. A user of the token must be able to verify the signature using their key in order to utilize the token. A token is said to be bound to an encryption key if the token must be validated The method includes receiving, from the TEE of the ML model release tool, into the TEE of the server, an ML model of the ML applications, where the ML model encrypted with the MEK, and decrypting using the MEK, by the TEE of the server, the ML model. The method further includes receiving, from a TEE of a provisioning server, into the TEE of the server, the ML application and a descriptor of the ML application, where the descriptor encrypted by a cryptographic key derived from the secret. The method includes executing the ML application using the ML model and the descriptor.

In further embodiments, the ML model is contained within an ML volume, and the ML model encrypted with the MEK.

In further embodiments, the MEK is tied to a user ID of an owner of the ML model and a hash is used to verify the integrity of the ML volume.

In further embodiments, the time-limited token is bound to a cryptographic key of the user computing device.

In further embodiments, the method also includes sending, by the user computing device, an attestation quote request to the server, where the attestation quote request includes the time-limited token. The method also includes receiving, by the user computing device, an attestation quote from the server, where the attestation quote is based on the TEE of the server. The method also includes sending, by the user computing device, an attestation report request for an attestation report to an attestation service, where the attestation report request includes the attestation quote and the access token. The method also includes receiving, by the user computing device, the attestation report, where the user computing device validates the attestation report.

In further embodiments, the MEK is bound to the ML application.

In further embodiments, the method also includes storing, by the server, the ML model in a model registry, where the ML model is sealed in the model registry, and receiving, by an ML-TEE, the ML model from the model registry, and unsealing the ML model.

In further embodiments, the method also includes the server sealing the ML application descriptor using a cryptographic key derived from the secret, where the server sends the ML application descriptor over a secure channel between TEE of a provisioning server and the TEE of the server, and the TEE of the server independently derives the cryptographic key derived from the secret stored therein.

In further embodiments, the ML application includes an ML engine and non-confidential data, and the ML application is executed on the ML engine using the non-confidential data.

In accordance with embodiments of the present invention, there is provided a system for executing a machine learning (ML) application in a computing environment. The system includes a plurality of computing devices, where each of the computing devices includes a processor and a non-transient memory for storing instructions which when executed by the processor cause the system to perform the methods describes herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 illustrates a computing environment according to an embodiment.

FIG. 2 illustrates a block diagram of a computing system that may be used for implementing the devices, systems, and methods according to an embodiment.

FIG. 3 illustrates the stages of the ML model's lifecycle according to an embodiment.

FIG. 4 illustrates the various steps taken by embodiments to assure the integrity and protect the confidentiality of ML applications.

FIG. 5 illustrates a ML learning framework for provisioning an ML model according to an embodiment.

FIG. 6 illustrates a method for an ML model developer to release a model, according to an embodiment.

FIG. 7 illustrates a method for securely provisioning an ML model into a cloud provider network, according to an embodiment.

FIG. 8 illustrates a method for securely provisioning an ML engine into a cloud provider network, according to an embodiment.

FIG. 9 illustrates a method for securely provisioning an ML engine into an ML-TEE of the cloud provider network, according to an embodiment.

FIG. 10 illustrates an overview of a method for authenticated and authorized remote attestation (A2RA) via IAM token binding, according to an embodiment.

FIG. 11 illustrates a method for user authentication and authorization, according to an embodiment.

FIG. 12 illustrates a method for remote attestation, according to an embodiment.

FIG. 13 illustrates a method of token validation, according to an embodiment.

FIG. 14 illustrates a method of secret provisioning, according to an embodiment.

It will be noted that throughout the appended drawings, like features are identified by like reference numerals.

### DETAILED DESCRIPTION OF THE INVENTION

Embodiments of the invention provide methods, apparatus, and systems to allow for the parties of artificial intelligence/machine learning (AWL) applications to preserve the security and confidentiality of their intellectual property (IP), such as models, engines, data, and applications, when executing in a potentially non-secure remote execution environment. The IP is provisioned to the execution environment and executed in a trusted execution environment (TEE) so that each parties IP is protected from each other as well as from the operators and owners of the execution environment. In some embodiments, the execution environment is a cloud computing environment.

Embodiments described herein include apparatus, systems, and methods for securely provisioning and operating a cluster of TEE containers running ML frameworks and ML applications on a cloud provider's infrastructure. Embodiments preserve the confidentiality and integrity of both the proprietary ML model and confidential user data during transmission, processing time, and at-rest within the cloud provider's infrastructure through the assistance of cryptographic modules, runtime isolation, and hardware security elements that are native to the computing environment or can be added via physical or network based interfaces. Some of the systems and methods described also contain optimizations that mitigate performance overhead introduced by security and privacy-preserving measures of embodiments.

Embodiments described herein include apparatus, systems, and methods for securely transmitting and receiving sensitive or confidential data between two computer systems where each computer system includes a trusted execution environment (TEE). In particular, cryptographic keys or secrets may be transferred from a TEE of one computer system to a TEE of a second computer system.

By way of generalized introduction artificial intelligence (AI) is the use of computer hardware and software to mimic “cognitive” functions typically attributed to human intelligence. AI applications are applications that attempt to “learn” or perform problem solving, rather than simply performing calculations. Some examples of AI applications include computer vision, natural language processing, self-driving cars, financial fraud detection, financial market prediction, medical diagnosis, etc.

Machine learning (ML) is a subset of AI and include computer programs and algorithms that are designed to improve through experience. ML algorithms include mathematical models that may be trained on sample data to be able to produce results without being explicitly programmed to produce those results. ML programming techniques are useful in solving problems where an explicit algorithm to solve the problem is unknown. ML models include parameters that are adjusted to improve the accuracy of the ML model's output. Training an ML model involves determining optimal values for the ML model's parameters. Once the ML model is “trained” it may then be used to make predictions. ML models can be classified into a number of categories such as neural networks, regression analysis, decision tree learning, etc. ML models are commonly referred to as AWL models but will be referred to as ML models herein.

ML models work by training their algorithms through the use of training data. Training data includes selected input and output data pairs where the output data is the “correct” or “best” answer given its corresponding input data. By processing data input and observing the output from the ML model, an error is obtained. The training process seeks to determine ML model parameters that minimize or limit the amount of error in the ML model outputs. In many AI/ML applications, large data sets from multiple sources are used in the training process. For example, a facial recognition application may use a large number of images of human faces for training. Often the ML model is owned by one party, and the data is owned by another party or parties. Data may also include data that is confidential or proprietary to the data owner.

ML models can be written as self-contained computer programs, but it is also common for classes of ML models to run on an ML engine designed for those classes of problems. For example, a number of different natural language AWL applications may use different models executed using an ML engine designed for natural language processing applications. Other classes of ML engines include facial recognition, voice processing, and others. The ML engine may be owned by a different party from the ML model owner or the data owner. Examples of ML models include AI Platform from Google, and Windows ML from Microsoft.

In some embodiment, ML applications may be used to package ML models with additional configuration code, programs, operating systems, script, parameters, etc. that allow the ML model to be run on the ML engine. In other embodiments, ML engines may be packaged with additional configuration code, script, parameters, etc. that allow the ML model to be run on the ML engine. The ML application may represent IP of the ML model owner, the ML engine owner, or may be a separate party. Non-confidential or public data may be combined with either the ML application or the ML model or be divided between the two.

The training and execution of ML models can require a large amount of computing power and data storage and therefore ML models are often run on cloud computing infrastructure. Some cloud computing operators provide their own ML engines, usually optimized for a particular application such as image recognition, text to speech, translation, etc. The cloud computing operator is often a different party then the ML model owner or the data owner. Cloud computing provides a flexible, on-demand source of computing power and data storage. Cloud computing is located remotely to the computing infrastructure of the ML model owner and is likely to be located remotely to the ML engine owner and data owner as well.

A trusted computing base (TCB) is a portion of a computer system that includes hardware and software that forms a trusted base to enforce a security policy of the computer system. The TCB may include a kernel, a small number of trusted processes, and hardware support that may be considered secure. If a portion of the computer system outside the TCB is compromised, the TCB portion will still be secure.

A trusted execution environment (TEE) may be part of a TCB and is a secure isolation environment within a computer process or system that is protected with respect to confidentiality and integrity. A TEE includes a set of hardware and software components that protect applications and data from external attacks. Many TEEs include a “hardware root of trust” using a set of private keys embedded in the hardware of the processor. These keys cannot be changed and can be used to control access and execution of software and data within the TEE. Within this specification, the TEE, group of TEEs, or cluster of TEEs that execute the ML model will be referred to as the ML-TEE. An attestation service which may be the manufacturer of the TEE hardware, may be used to verify the security of the TEE. In some cases, a hardware key may be revoked by the hardware vendor in cases of mishandling or if the key is suspected of being compromised by an attacker.

Embodiments provide improved security for ML models, security and privacy for user data, and provide increased performance while implementing these security and privacy measures.

Embodiments safeguard the ML model itself and the values of parameters of the trained ML model or ML application. Aspects of the ML model remains confidential in transit, when provisioning a ML model from the AI/ML company to the cloud provider's infrastructure, and at rest, when the model is stored or running on the cloud provider's infrastructure.

Embodiments protect the security and privacy of user data that may be utilized by ML models. Data may be protected irrespective of the sensitivity, such as whether it is confidential or public knowledge. Data is protected while being provisioned to the cloud provider and while being used by an ML model in a TEE provided by the cloud provider for the secure execution of the ML model, hereafter referred to as an ML-TEE. The confidentiality and integrity of user data is protected from outside actors. Only user's whose encryption key is provisioned within the cloud provider ML-TEE are able to transfer data in and view results based on that data. The ML-TEE provides security guarantees for protecting data that is securely provisioned into it or computed inside of it.

Embodiments ensure performance in the presence of the security and privacy measures of other embodiments. Adding security or privacy measures to a system increases performance overhead. Optimizations are added in the form of OS and kernel level features to mitigate the overhead of filesystem I/O, network I/O, and cache performance when executing the ML framework upon which the ML models are based. Embodiments include low-level optimization methods that speed-up performance of a ML framework with known patterns of system calls.

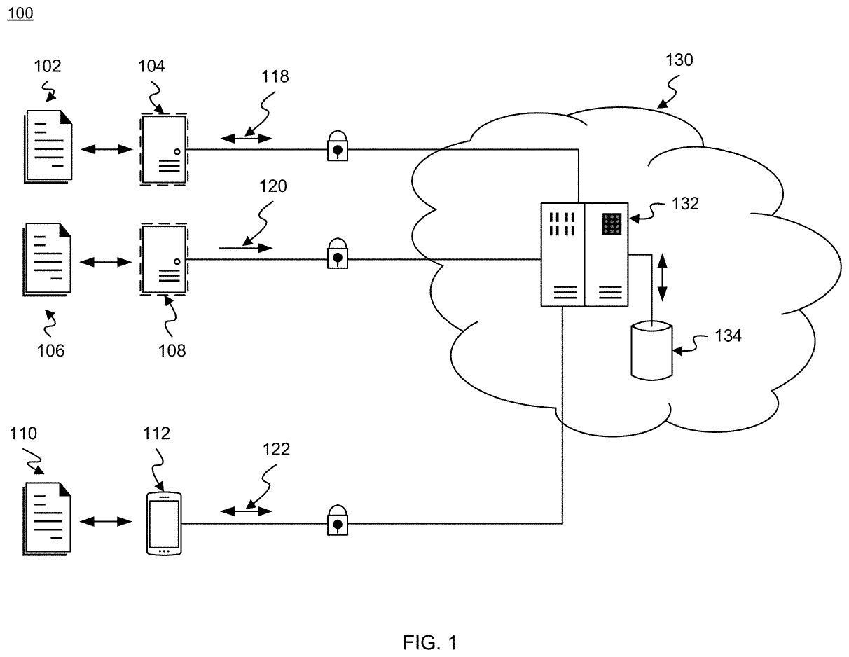

FIG. 1 illustrates a computing environment according to an embodiment. A ML model 102, or ML application, may be owned by a company, organization, or similar group. Computing resources 104 that are local to, owned by, leased by, or controlled by the ML model owner are used to develop and store the ML model 102. The ML model owner is able to securely transmit the ML model 102 over network link 118 to cloud computing provider 130 and to receive information from the cloud computing provider 130 such as updated model parameters. ML engine 106 is similarly stored in computing resources 108 and the ML engine owner is able to securely transmit the ML engine 106 over network link 120 to cloud computing provider 130. Data 110 is proprietary to an associated data owner and may be stored in computing resources 112 that are local to, owned by, leased by, or controlled by the data owner. Similarly to the ML model owner, the data owner is able to transmit data 110 securely over network link 122 to the cloud computing provider 130 as well as receive results produced by the ML application after it is executed. Cloud computing provider 130 includes computing resources 132 and storage 134. Cloud computing resources 132 may include physical and virtual servers, may be centralized or distributed, and include any number or combinations of computing resources as are known in the art. Cloud computing resources 132 may include specific servers for provisioning data into and out of the cloud 130, servers that act as proxies for other servers, and servers for executing, managing, and storing ML models 102, ML engines 106, or user data 110. Cloud storage 134 may similarly include any number or combinations of computer storage as are known in the art. The ML model 102, ML engine 106, and data 110 may be owned by separate entities or an entity may own more than one of the model, engine or data. The cloud computing provider 130 may also own one or more of the model, engine, or data. Embodiments assume that integrity and confidentiality may have to be maintained between any or all of the parties involved.

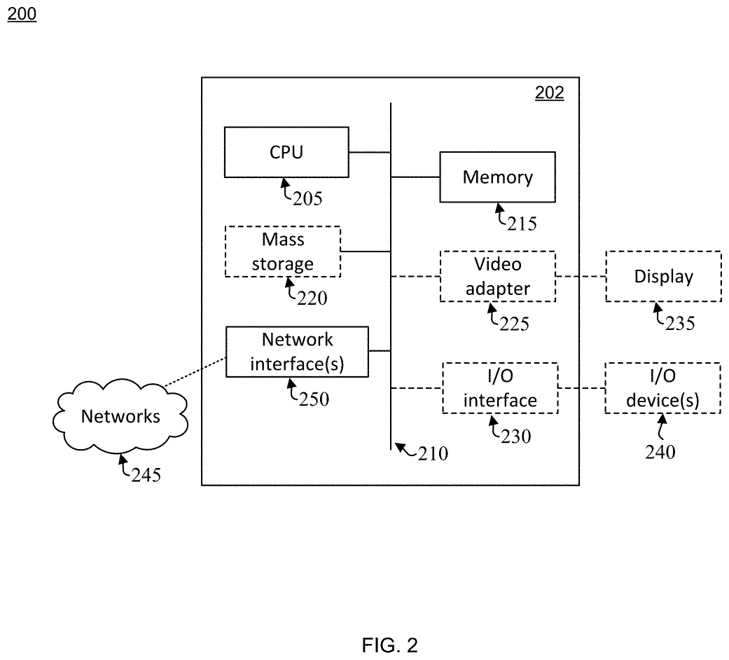

FIG. 2 is a block diagram of a computing system 200, such as a computer, a server, or a network device that may be used for implementing the devices, systems, and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 200 includes a processing unit 202. The processing unit 202 typically includes a central processing unit (CPU) 205, a bus 210 and a memory 215, and may optionally also include a mass storage device 220, a video adapter 225, and an I/O interface 230 (shown in dashed lines).

The CPU 205 may comprise any type of electronic data processor. The memory 215 may comprise any type of non-transitory system memory such as static random access memory (SRAM), dynamic random access memory (DRAM), synchronous DRAM (SDRAM), read-only memory (ROM), or a combination thereof. In an embodiment, the memory 215 may include ROM for use at boot-up, and DRAM for program and data storage for use while executing programs. The bus 210 may be one or more of any type of several bus architectures including a memory bus or memory controller, a peripheral bus, or a video bus.

The mass storage 220 may comprise any type of non-transitory storage device configured to store data, programs, and other information and to make the data, programs, and other information accessible via the bus 210. The mass storage 220 may comprise, for example, one or more of a solid state drive, hard disk drive, a magnetic disk drive, or an optical disk drive.

The video adapter 225 and the I/O interface 230 provide optional interfaces to couple external input and output devices to the processing unit 202. Examples of input and output devices include a display 235 coupled to the video adapter 225 and an I/O device 240 such as a touch-screen coupled to the I/O interface 230. Other devices may be coupled to the processing unit 202, and additional or fewer interfaces may be utilized. For example, a serial interface such as Universal Serial Bus (USB) (not shown) may be used to provide an interface for an external device.

The processing unit 202 may also include one or more network interfaces 250, which may comprise wired links, such as an Ethernet cable, and/or wireless links to access one or more networks 245. The network interfaces 250 allow the processing unit 220 to communicate with remote entities via the networks 245. For example, the network interfaces 250 may provide wireless communication via one or more transmitters/transmit antennas and one or more receivers/receive antennas. In an embodiment, the processing unit 202 is coupled to a local-area network or a wide-area network for data processing and communications with remote devices, such as other processing units, the Internet, or remote storage facilities.

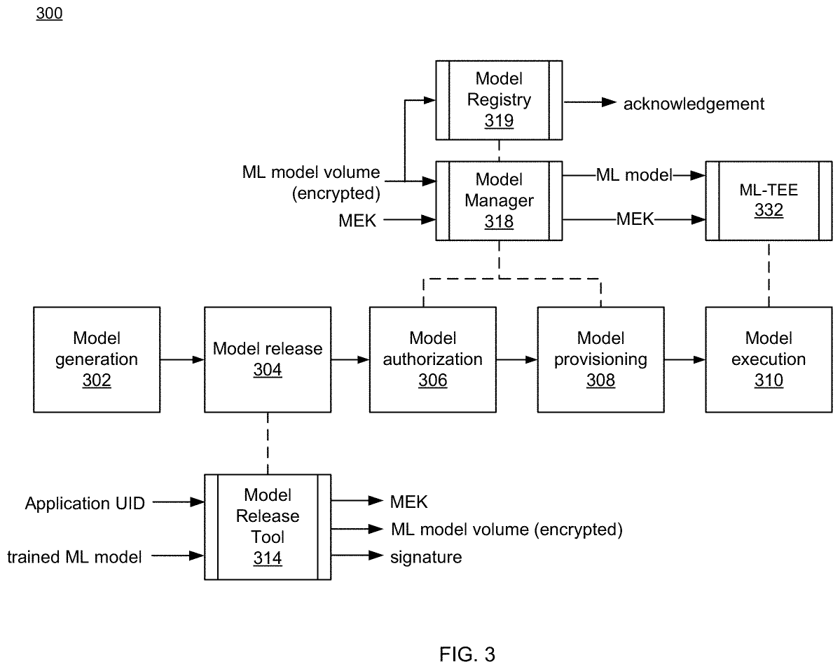

Embodiments preserve the confidentiality and protect the integrity of the ML model throughout the stages of the AWL model's lifecycle 300. The stages of the ML model's lifecycle 300 are illustrated in FIG. 3 and include model generation 302, model release 304, model authorization 306, model provisioning 308, and model execution 310.

The model generation 302 step is specific to each application and is performed by AWL developers and businesses. Model generation 302 is performed in a secure computing environment and includes determining the data that is to be used in the training of the ML model. An output of the model generation 302 step may be an ML model and is in a state where it is ready to be deployed into a training environment. The final output of the model generation 302 step may be a trained ML model and is in a state where it is ready to be deployed into a production environment. ML models can be classified as static or dynamic. A static ML model is trained offline as part of the model generation 302 or model release 304 step. Once trained, the ML model may then be used in a computing environment. Offline training may be performed as a later time to update the model and its parameters. A dynamic ML model is trained online as part of the model execution 310 step. As the ML model is run it is updated as part of a continuous process. Security mechanisms used for confidentiality and integrity protection may be customized depending on if the ML model is static or dynamic.

The model release 304 is used by the ML model owner to safeguard the confidentiality and integrity of the released ML model 102. Developers of ML models utilize a model release tool 314 that is a software application, routine, or function that is responsible for generating encrypted and signed archives or volumes that can be securely mounted and extracted in an execution environment for execution of the ML model 102. To be secure, model release tools 314 may be required to meet a number of criteria. Model release tools 314 may utilize a hardware security element for safeguarding keys and sensitive cryptographic operations within its trusted execution environment (TEE). Model release tools 314 should be deployed in a secure, restricted computing environment with adequate security clearance. A model release tool 314 takes as input an application user identification (UID) and the ML model 102. The model release tool 314 generates as output a model encryption key (MEK) bound to the application UID, an archive or volume containing the ML model encrypted with the MEK, and a signature using the ML model owner's signing key. By way of introduction, encrypting the ML model with the model encryption key (MEK) includes mathematically encrypting the ML model (one or more computer files) with the encryption key for that model. In some embodiments the MEK may be ephemeral, only be valid for a time sufficient to complete the provisioning and execution of the ML model 102. The signature may be used to authenticate the developer or owner of the ML model 102. The MEK may be generated and stored by the model release tool's 314 TEE and may be used by other TEEs using the model authorization process 306. The MEK may be securely provisioned into TEEs of other computer systems such as the ML-TEE of the cloud computing provider 130.

Model authorization 306 includes processes for authenticating and authorizing a remote party, such as a cloud computing provider 130, to access a ML model volume generated by the model release tool 314 in the model release 304 step. At the cloud computing provider 130, a software component known as a model manager 318 may be configured to listen for incoming network connections from the model release tool 314. The model authorization 306 process starts when the model release tool 314 provisions the MEK into a model manager 318 TEE through a remote attestation procedure described herein. Remote attestation starts when the model release tool 314 uses the MEK to encrypt the ML model volume. The next step is that the model release tool 314 sends the ML model volume to a model registry 319 for long term storage. Finally, the model registry 319 responds with an acknowledgement upon successful storage of the ML model volume in the cloud provider's storage. The model release tool 314 is part of the ML model owner's computing environment 104. The model manager 318 and the model registry 319 are part of the cloud computing environment 130.

The above process takes place between ML model company's model release tool 314 and the model manager 318 and model registry 319. In some embodiments, the model manager 318 and model registry 319 can be in a segregated private cloud owned by the ML model company, which is an example of infrastructure as a service (IaaS), or it can be shared among multiple tenants, examples of a platform as a service (PaaS) or a container as a service (CaaS). Once the ML model 102 is stored in the model registry 319, ML-TEEs are able to be provisioned with the ML model volume for execution. Prior to being able to use the ML model volume, the ML-TEE is provisioned with the ML model's MEK by the model manager 318 using the model provisioning 308 procedure.

Model provisioning 308 is performed by the model manager 318 and includes authorizing ML-TEEs of the cloud computing provider and securely distributing the MEK of the ML model that is to be executed in the ML-TEEs. Model provisioning 308 is initiated by the ML model owner by passing a deployment configuration to an orchestrator component of the cloud computing provider. The orchestrator defines the attributes of the ML-TEEs that the ML model is to be deployed in for execution. The deployment configuration may include an application UID, a ML model UID, service account credentials, and cluster size of the cloud computing provider TEEs.

The orchestrator takes the deployment configuration and interfaces with the model manager, model manager, and ML-TEE hosts to launch containers that satisfy the configuration provided by the system administrator. Before executing any actions on behalf of the system administrator, the orchestrator will validate the service account credentials to ensure the administrator is authenticated and authorized. By way of generalized introduction, the process of software “validation” includes mathematically verifying that (user) credentials, (encryption) keys, tokens, cryptographic secrets, cryptographic signature, etc. are valid and may be trusted. Validation prevents the use of unauthorized information or the granting of unauthorized access to software resources.

The MEK stored by the model manager 318 is transferred to ML-TEEs that will execute the ML model in the cloud computing environment 130. A secure transfer will take place between the model manager 218 and a ML-TEE daemon running on each of the machines hosting the cluster. The ML-TEE daemon will transfer the MEK to the ML-TEE as part of the ML-TEE launch process. Transfers of the MEK are done over secure channels between TEEs running as parts of logical components. Therefore, the MEK is never stored or used outside of a TEE enclosure.

Model execution 310 occurs when the ML-TEE 332 launches a ML application and an ML model. The application uses the MEK provided by a ML-TEE daemon to decrypt the mounted volume holding the ML model. Upon successfully decrypting and mounting, the ML-TEE loads the ML model with the ML engine associated with ML model and resumes execution. The decryption process of the ML model may use cryptographic algorithms that can verify the integrity of the ML model and that originated from the ML model owner. The integrity of the ML model can be verified by using known authenticated encryption algorithms like AES-GCM. The origin of the ML model may be verified by performing cryptographic verification on the signature of the ML model and validation of the ML company's associated certificate. At this point, the ML-TEE can trust that the ML model is legitimate and has not been tampered with. The origin of the ML model is only verifiable for static models that are frozen at the time of model release.

The embodiment of FIG. 3 provides the means to transmit the ML model in encrypted form between the ML model owner 104 and the cloud computing infrastructure 132 using a two stage process. Encryption is done using the ephemeral MEK which may be based on hardware TEEs. In the first stage, the model release tool 314 exports the encrypted ML model to the model manager 318. In the second stage, the model manager 318 provisions the encrypted ML model into the ML-TEE.

The ML owner is able to issue authorization tokens to ML-TEEs in the cloud computing environment 130 that can run their ML models. By way of generalized introduction, an authorization token is a computer software object that contains a security identity to indicate that the ML-TEE is authorized by the ML owner. A “time-limited” token is a token that is only valid for a predetermined period of time or until a criteria or set of criteria is met. Software routines accessing the token must verify that the time-limited nature of the token has not expired, and it may still be utilized. The ML-TEE provides the authorization token to the model manager 318 during start-up in order to download the ML model and its MEK during start-up. The authorization token can be time-limited to prevent against future unauthorized access in the event the authorization token is leaked. A time-limited authorization token is only valid for a defined period of time, after which, the token becomes invalid and may not be used. When a time-limited token is accessed, the accessing software will verify that the token has not expired before utilizing it.

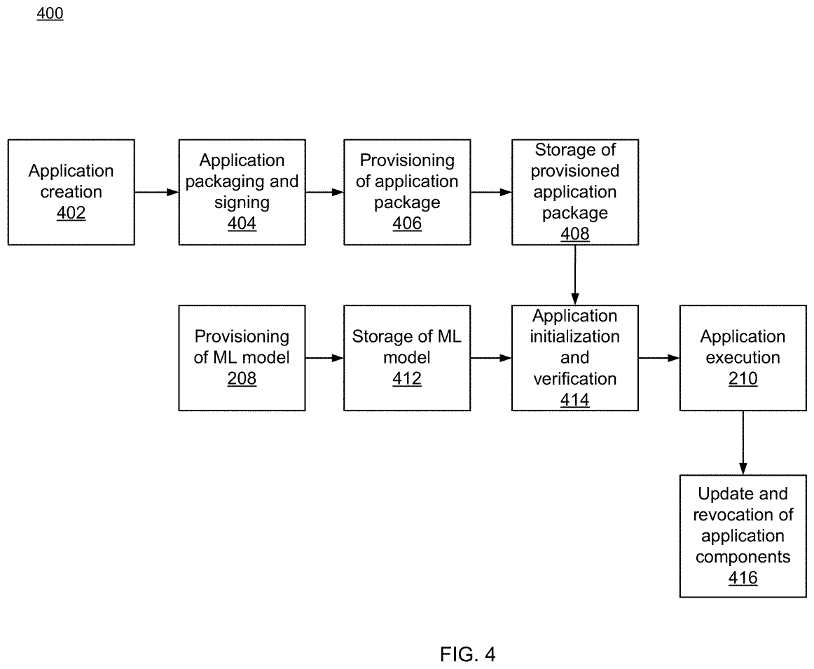

ML applications include an ML model together with associated programs, operating system, parameters, variable, or other information required for the execution of the ML model with the ML engine in the cloud computing environment. FIG. 4 illustrates the various steps taken by embodiments to assure the integrity and protect the confidentiality of ML applications. These steps are application creation 402, application packaging and signing 404, provisioning of the application package 406, storage of the provisioned application package 408, provisioning of the ML model 208, storage of ML model 412, application initialization and verification 414, application execution 210, and update and revocation of application components 416.

The ML application creation 402 step is specific to each individual application and is where the ML model owner develops their ML model for an application. The ML application creation 402 step is assumed to be trustworthy and uncompromised in its entirety at the time it is built and up to the application packaging and signing 404 step.

The ML model owner then performs the application packaging and signing 404 step in a secure environment using trusted tools. Depending on how the execution environment of the cloud computing provider 130 is configured, the application may include a file system, such as Linux, or a portion of a file system with components sufficient to execute the ML model. Non-confidential, public data, or data owned by the application developer may also be included in the application package. Application executables and non-confidential data are packaged with a file system backed by a regular file. The package files are signed for integrity-protection. The application packaging and signing 404 step may require a separate computer function to verify the signed package files. One example of this type of computer function is the Linux, dm-verity kernel component which performs verification and checks integrity at the disk block level. The application packaging and signing 404 step may involve constructing a hash tree of the file system blocks, which may be a Merkle hash. A Merkle hash is a data structure with a tree structure in which each leaf node is a hash of a block of data, and each non-leaf node is a hash of its children. Typically, each node of the Merkle hash can have up to 2 children. A Merkle hash may be used for efficient data verification since it uses hashes instead of full files. The application packaging and signing 404 step produces an integrity-protected file system image (now including the hash tree) along with an application package descriptor structure containing the file system root hash. The value of the latter is integrity-protected at all stages. In embodiments, the application adheres to Kerchhoff's principle that states that the application package code itself does not need to be kept secret. As the application package is not encrypted, any overhead due to decryption is reduced.

Any confidential application data may be packaged in one or several separate file system images using the same packaging and signing 404 procedure, with the addition of an encryption step to produce a confidentiality-protected file system image. The encryption step may be done at the file system block level using a block cipher with a symmetric key. One example of a computer function to perform the encryption is the dm-crypt Linux kernel component which is designed to perform disk encryption.

A provisioning of application package 406 step may be used to verify or decrypt file system images belonging to an application package produced by the application packaging and signing 404 step. As part of the provisioning of application 406 step, corresponding root verification hashes and encryption keys must be passed inside a ML-TEE container that is expected to execute the application package. In some embodiments, a ML-TEE container is required to execute multiple applications which may have been developed by different AI/ML companies, so the association between applications and their respective keys and hashes is also tracked.

The provisioning of application package 406 step uses an application package descriptor data structure in order to provision the application package to the cloud computing ML-TEE. In some embodiments, the data structure may contain the following fields:
Root verification hashes for each integrity-protected file system image.
Encryption keys, which may be symmetric keys, for each confidentiality-protected file system image.
Application UID.
Model UID.
Information required for associating root hashes and encryption keys with corresponding file system image structures.

Secure transfer of the application package descriptor data structure into the ML-TEE container is performed using a multi-step process. First the application package descriptor is delivered to a provisioning proxy infrastructural TEE task of the cloud computing environment 130. The provisioning proxy may run on the same host as the ML-TEE container. Next, the provisioning proxy infrastructural TEE task seals the application package descriptor in persistence (in some form of non-volatile memory), so that the application package descriptor is preserved even after the provisioning proxy infrastructural TEE task has ended. Sealing is the process where the ML-TEE encrypts data using key that has been provisioned into the ML-TEE. Unsealing is the inverse process to sealing when the ML-TEE decrypts data using the keys that were provisioned into the ML-TEE. Finally, the ML-TEE container unseals the application package descriptor from persistence when required to verify and execute the application corresponding to the application package descriptor.

Embodiments also allow for alternative methods for transferring the application package descriptor data structure into the ML-TEE container such as secure dynamic channels based on local attestation, transport layer security (TLS) connections, etc.

In the provisioning of application package 406 step, sealing and unsealing is performed by the same symmetric keys, known as seal keys, which are derived by the ML-TEE facilities based on secrets that are shared by the provisioning proxy TEE task and a TEE container task. This process is secure since the seal keys are derived within the TEE domain to which the TEE container tasks belong and never leave the boundaries of the ML-TEE. The seal keys are derived from a parent key and additional identifiers unique to the ML-model, application package descriptor, or application. Seal keys are used inside the ML-TEE to encrypt and sign the application package descriptor structure. Seal keys may use an AES-GCM cipher, where a single seal key provides both a message authentication function (MAC) and encryption. The resulting signed ciphertext may then be persisted in a regular unencrypted file. By virtue of the seal key construction, the contents of a file can only be successfully decrypted inside the ML-TEE bearing the same identity as the contents' creator. Similarly, any corruption is detected through verification inside the same ML-TEE. Verification is supported by the GCM mode and is performed at the time of decryption.

In the storage of provisioned application package 408 step, the provisioning proxy infrastructural TEE task is responsible for sealing the application package descriptor structure in persistence upon successful reception of the provisioned data. The persisted sealed state is represented at the cloud computing provider 130 by a regular file on a file system accessible by regular computing units.

The ML-TEE container and the provisioning proxy TEE task share the TEE identity and exist in the same root of trust domain. This enables the TEE container to unseal the application package descriptor structure when required.

In order for the ML-TEE to execute the ML application, the ML-TEE requires the ML model and encapsulated supporting data, both of which may be maintained as separate entities for a number of reasons. One is that a specific application could be used with different ML models depending on application or user-specific configuration. Another reason is that the application and model images can be updated or revoked independently of each other.

In the provisioning of ML model 208 step, a ML model is packaged in an integrity-protected file system image, signed and encrypted with a key specific to the ML model. The provisioning workflow is similar to that of the application package itself described above. A provisioning service component is used to securely transfer a ML model descriptor structure to the cloud computing provider 130 CPU that hosts the ML-TEE container. The ML model data structure may contain the following fields:
A root verification hash for the integrity-protected file system image containing the ML model.
Symmetric encryption/decryption keys for the file system image containing the ML model.
A ML model UID.
Information required for linking the root hash and encryption key with the file system image containing the ML model.

In embodiments, the secure transfer of the ML model package descriptor structure into the ML-TEE container may be accomplished using the following method.
The ML model descriptor structure is sent to the provisioning proxy infrastructural TEE task that runs on the same host as the ML-TEE container.
The provisioning proxy infrastructural TEE task seals the descriptor in persistence.
The ML-TEE container unseals the descriptor from persistence when required to verify and load the corresponding model image.

The storage of ML model 412 step includes the storage of the provisioned ML model in persistence. A similar method to the storage of provisioned application package step 408 may be used as the sealing mechanism for the model, including using the same key derivation scheme.

Similarly to the provisioning of application package 406 step, the provisioning proxy infrastructural TEE task is responsible for sealing the model package descriptor structure in persistence upon successful reception of the provisioned data. The persisted sealed state is represented by a regular file on a file system accessible by a cloud computing provider 130 CPU host, thus allowing the ML-TEE container to load, unseal and verify the ML model image.

In order to perform the application initialization and verification 414 step, a ML-TEE container loads the application package descriptor structure from the sealed state into protected ML-TEE memory. This structure is trustworthy by virtue of the mechanisms described with regards to the provisioning of application package 406 step.

While in persistence, an application always resides in an integrity-protected file system image. As part of the application loading process, this image is fetched from storage and mounted by the ML-TEE container. When mounting the file system image, the ML-TEE container ensures that the root hash value stored with the image matches the trusted version in the application package descriptor structure. Only when the two are equal is the mounting operation allowed to proceed.

The ML-TEE container loads the file system hash tree into protected ML-TEE memory. Should any part of the hash tree become corrupted, a hash verification failure will be detected when dependent data is requested by the container I/O layer. Similarly, attempting to read corrupted file system data blocks will result in a hash mismatch. This may be an ongoing process that lasts while the file system image is mounted. This process will detect modification of files, data, or disk sectors as they are read by the ML-TEE, irrespective of when such modification occurred.

The ML application is executed in the application execution 210 step. While in use, application executables and data components reside in integrity and confidentiality protected ML-TEE memory and are protected against accidental and malicious modification, as well as against eavesdropping. The trustworthiness of the ML-TEE application image is assured, on the one hand, by the ML-TEE container trusted computing base (TCB) and, on the other, by the mechanism described previously (3.3.3.5).

At the end of the application execution 210 step, the update and revocation of application components 416 step may be used to provide a mechanism to update or revoke an application's components or authorization by replacing the application package descriptor structure.

In order to implement a confidential computing ML framework “secrets,” such as encryption keys, signing keys, and other user encryption parameters that must be provisioned into a TEE, such as the cloud computing provider 130 ML-TEE. In the case of machine learning where a user's confidential data is transmitted into cloud computing infrastructure 130, TLS using keys that are not hardware protected, or when keys are used to decrypt user data outside of a TEE pose a threat of user data leaking or being intercepted by a malicious insider. To mitigate this threat, the TLS connection must either terminate inside of a TEE itself or the user can encrypt their data with an application specific symmetric key that they themselves have generated and securely provisioned into a TEE.

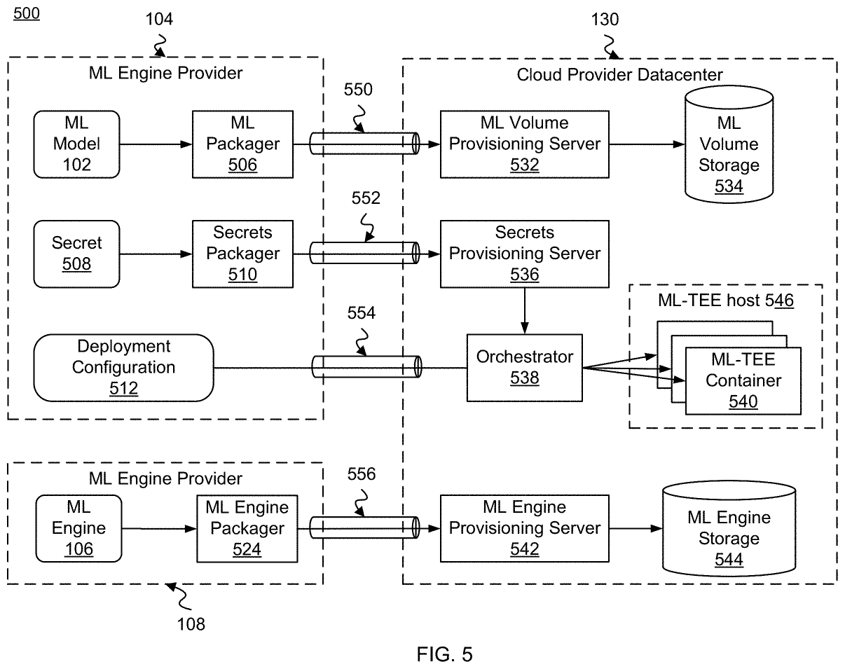

FIG. 5 illustrates a ML learning framework for provisioning an ML model 102, secret 508, and ML engine 106 into a cloud provider datacenter 130 according to an embodiment. An ML engine provider 104 provides the ML model 102, the secret 508, and a deployment configuration 512. An ML engine provider 108 provides an ML engine 106. A cloud provider datacenter 130 includes servers to receive the ML model 102, secret 508, deployment configuration 512, and ML engine 106. In embodiments, the ML engine provider 104 and the ML engine provider may be the same entity. In embodiments, the ML engine provider may be part of the cloud provider datacenter 130.

ML model 102 includes a collection of directories and files describing the ML model. Secret(s) 508 includes one or more encryption keys, passwords, certificates, private keys, and other cryptographic data as is known in the art to perform attestation and encryption. Deployment configuration 512 includes descriptions and configuration of hardware, networking, storage parameters, and other information required by the cloud provider datacenter 130 to secure, store, and execute the ML model 102. An ML packager 506 encrypts and signs ML model 102 for release and attaches metadata necessary for storage volume generation and transfer over secure channel 550 to the cloud provider datacenter 130. Similarly, a secrets packager 510 is used to encrypt and signs secrets 508 and performs remote attestation between endpoints in the secrets package 510 and cloud provider datacenter 130 over secure channel 552.

ML engine provider 108 provides ML Engine 106, an ML application suite for executing ML models such as ML model 102. ML engine packager 524 is used to prepare the ML engine 106 for transmission over secure channel 556 to the cloud provider datacenter 130.

Secure channels 550, 552, 554, and 556 may be separate or combined and include TEEs at each end of the secure channels.

The cloud computing datacenter 130 provides a secure environment to accept the components required to execute the ML application; the ML model 102, secrets 508, ML engine 106, and other public data. The ML model 102 package is received over secure channel 550 into ML volume provisioning server 532. ML volume provisioning server 532 repackages the ML model in a standard format that allows it to be mounted as a virtual storage disk. The ML model 102 is then stored in ML volume storage 534, a repository that stores ML volumes and their corresponding metadata.

The packaged secrets 508 are received over secure channel 552 into secrets provisioning server 536. Secrets 508 received by secrets provisioning server 536 may then be used in the initialization of ML-TEE containers within cloud computing datacenter 130.

Orchestrator 538 receives a deployment configuration 512 from the ML engine provider 104 over secure channel 554. Orchestrator 538 utilizes the deployment configuration 512 to schedule the creation and destruction of ML-TEEs and manages their lifecycle.

The ML engine provisioning server 542 received the ML engine 106, packaged by ML engine packager 524 from over secure channel 556. ML engine provisioning server 542 creates a runtime engine image with all dependencies and stores it in ML engine storage 544. ML engine storage 544 provides a repository for ML engine images and their metadata.

The ML-TEE host(s) 546 includes any number of ML-TEE containers 540. Each ML-TEE container is an isolated TEE-based execution environment for ML Images and ML Volumes that run services relating to the business function of the ML Model.

ML volume provisioning server 532, secrets provisioning server 536, ML engine provisioning server 542, and orchestrator 538 are real or virtual servers, or server processes or functions with a TEE environment that can securely receive, store, and process sensitive data uploaded by developers and users.

Secure channels 550, 552, 554, and 556 may be physical or virtual channels. They may be shared channels or tunnels or be isolated or combined using methods as known in the art.

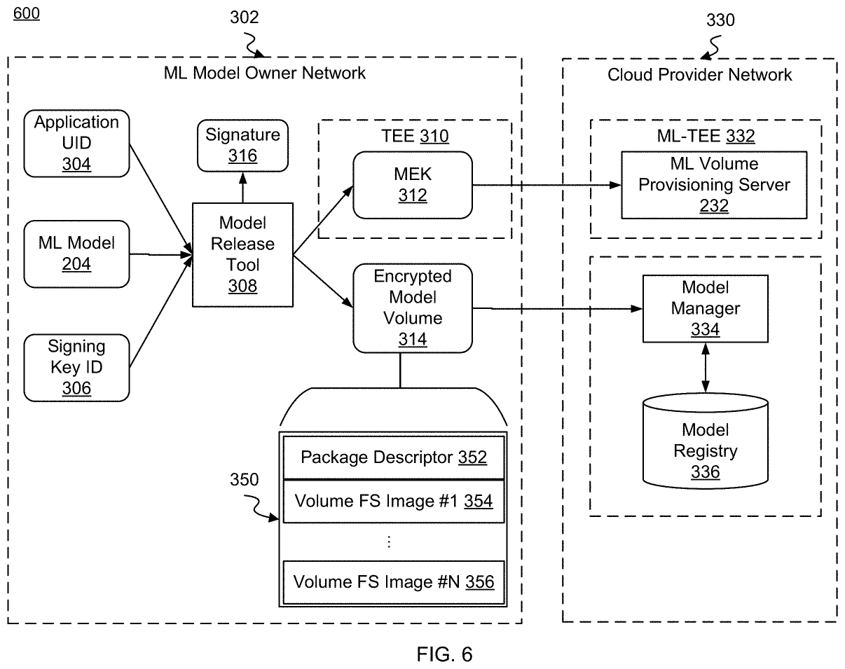

FIG. 6 illustrates a method for an ML model developer to release a model, according to an embodiment. The method allows an ML model developer to securely provision an ML model into the cloud provider network 330.

The ML model developer operates an ML model owner network 302 that includes at least one TEE 310. Inputs used by model release tool 308 include ML model 204, an application UID 304, and a signing key ID 306. Model release tool 308 produces as outputs, a signature 316. Signature 316 includes a developer created encryption key for the model. MEK 312, a developer created encryption key for the model, is stored within a secure environment with a TEE 310 and is provisioned into the ML-TEE 332 of the ML volume provisioning server 232 in the cloud provider network 330. The model release tool 308 also packages ML volume 350 and creates encrypted model volume 314 with signing ID key 306. Model volume 350 includes a package descriptor 352 describing the contents of the model volume. Model volume 350 also includes one or more volume file system (FS) images 354, . . . , 356. The encrypted model volume 314 containing the ML model 204 and the package descriptor 352 is securely transferred to the model manager 334 of the cloud provider network 330. The model manager 334 stores the encrypted model volume 314 in a model registry 336.

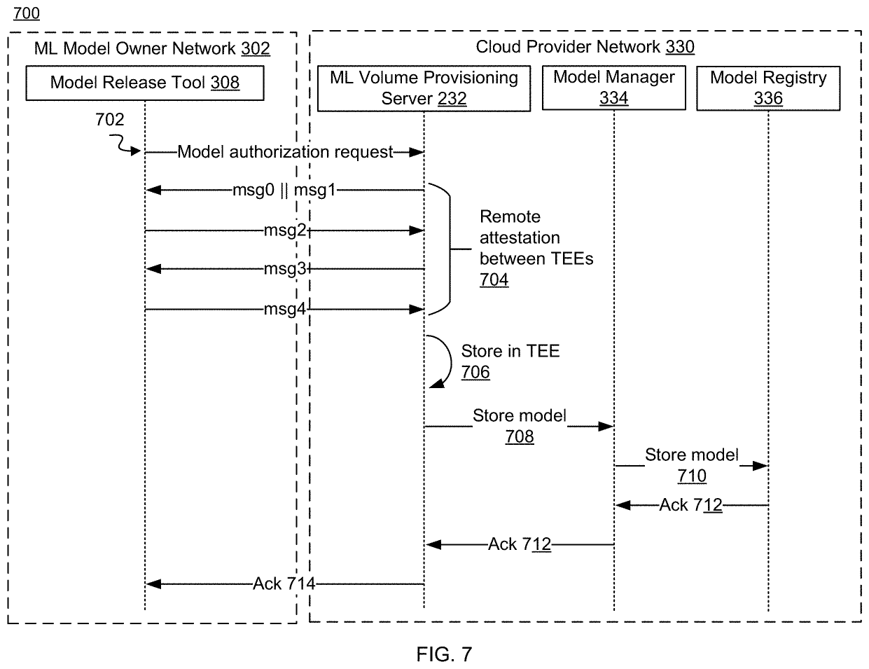

FIG. 7 illustrates a method for securely provisioning an ML model into a cloud provider network, according to an embodiment. The method may also perform an authorization process as part of the method. Model release tool 308 in the ML model owner network 302 initiates the method by sending a model authorization request 702 to ML volume provisioning server 232. The model authorization request 702 may include the ML model encrypted with the MEK, Enc_{MEK}(m), a signature, Sign_{SK}(a), of the encrypted model. and a unique model ID, m_{ID}. A number of messages are then exchanged between the model release tool 308 and the ML volume provisioning server 232 to perform a remote attestation process 704 between the TEE of the model release tool 308 and the TEE of the ML volume provisioning server 232. In FIG. 7 four messages are exchanged in order to perform remote attestation but in embodiments the number of messages, order of messages, and direction of messages may vary. At the completion of the remote attestation process 704 the model release tool 308 sends a message to the ML volume provisioning server 232 that may include a session key, Enc_{SESSION KEY}(MEK), encrypted with the MEK.

Once remote attestation 704 is successfully completed the ML volume provisioning server 232 may store 706 the ML model 204 in its TEE secure enclave. The ML volume provisioning server 232 may then store 708 the ML model 204 into the model manager 334 using a StoreModel message that may utilize the model ID, m_{ID}, and the encrypted model signature, Sign_{SK}(a). The ML model 204 is stored using the m_{ID} and is encrypted using the MEK. The model manager 334 stores 710 the ML model 204 into the model registry 336, which is acknowledged 712 by the model registry 336. To complete the process the model manager acknowledges 712 the completion to the ML volume provisioning server 232, which sends an acknowledgement to the model release tool 308.

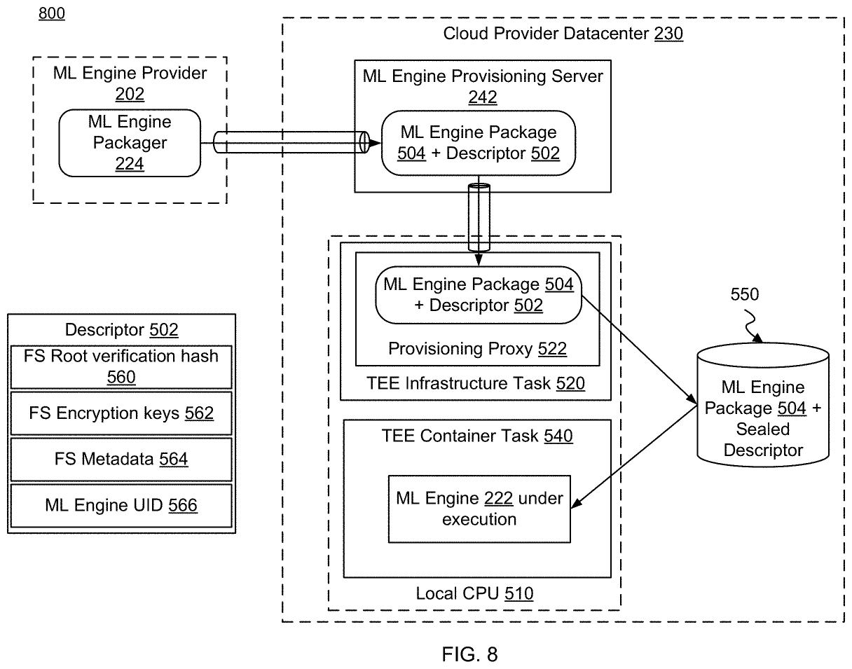

FIG. 8 illustrates a method for securely provisioning an ML engine 106 into a cloud provider network 130 in order to provide mechanisms for secure ML engine initialization, verification and execution, according to an embodiment. An ML engine 106 represents a set of runtime components and any supporting data required to execute an ML model 102. The ML engine 106 is designed to provide security guarantees to both the ML model owner and the owner of confidential or proprietary data being utilized. To that end, parts of an ML engine 106 are integrity protected. Certain components of an ML engine 106 may in addition be confidentiality protected.

In embodiments, ML engine provider 202 utilizes ML engine packager 224 to package and cryptographically sign the ML engine 106. The ML engine package may include one or more Linux file systems that are described by a descriptor 502 that collects the parts of the ML engine package. These parts include a file system (FS) root verification hash 560, FS encryption keys 562, FS metadata 564, and an ML engine UID 566. The ML engine packager 224 is in communication with an ML engine provisioning server 542 of the cloud provider datacenter 230, to send the ML engine package 504 and descriptor 502 to a secure enclave of the ML engine provisioning server 542. Once in the cloud provider datacenter 230 environment the ML engine package 504 may be distributed to local CPU 510 which may execute a TEE infrastructure task 520 to implement a provisioning proxy 522. The ML engine package 504 and descriptor 502 may then be sealed 550 into cloud storage to provide secure storage of the ML engine and associated metadata. In order to be executed the ML engine package 504 and descriptor 502 are unsealed and read from cloud storage into a TEE container task 540 and executed.

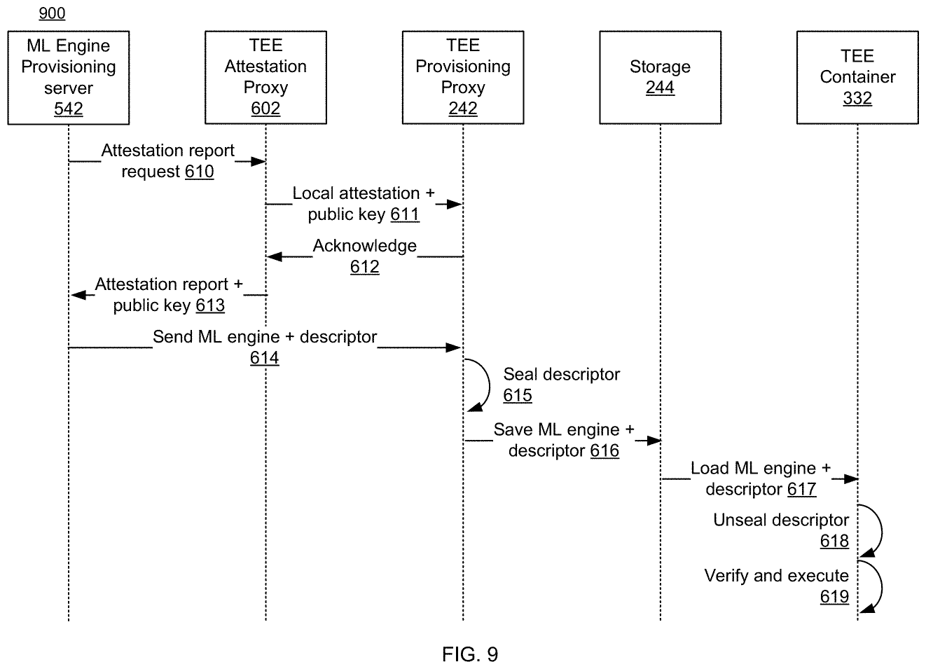

FIG. 9 illustrates a method for securely provisioning an ML engine into an ML-TEE of the cloud provider network, according to an embodiment. The secure transfer of the application package descriptor structure into a TEE container 332 happens as a result of the several events. The descriptor 502 may be delivered securely to the TEE provisioning proxy 242 that runs on the same host and in the same TEE environment as the TEE container 332 of the ML provisioning server 542. The TEE provisioning proxy 242 seals the descriptor in persistence. Finally, the TEE container 332 unseals the descriptor 502 from persistence when required to verify and execute the ML application.

The method may be initiated by an ML engine provisioning server 542. The ML engine provisioning server 542 has responsibilities such as performing attestation between TEEs before provisioning any data, receiving and verifying the ML engine package, and creating an application package descriptor which uniquely identifies and securely signs the application package for deployment.

The method may be conducted within the cloud provider datacenter 230 and starts when the ML engine provisioning server 542 makes an attestation report request 610 to a TEE attestation proxy 602 which is a local TEE component responsible for serving attestation requests. The TEE provisioning proxy 242 executes a task that is responsible for sealing the ML Engine package descriptor 502 structure in persistence upon successful reception of the provisioned data. In turn, the TEE attestation proxy 602 sends a local attestation request 611 together with a public key to a TEE provisioning proxy 242. The TEE provisioning proxy 242 performs the local attestation and responds with acknowledgement 612. When the TEE attestation proxy 602 received acknowledgement 612, it may return an attestation report 613 and public key to the ML engine provisioning server.

Once the ML provisioning server 542 receives the attestation report 613 it can send 614 the ML engine 106 together with the descriptor 502 to the TEE provisioning proxy. Upon successfully receiving the provisioned data, a task of the TEE provisioning proxy 242 can seal 615 the ML engine package descriptor structure 502 in persistence. Seal keys are derived from a TEE-rooted key and additional identity material. Seal keys never leave the boundaries of the TEE. Once the descriptor 502 is sealed, the TEE provisioning proxy 242 may save 616 the ML engine 106 and the descriptor 502 into storage 244.

In order to execute the ML engine 106, the TEE container 332 loads 617 the ML engine 106 and the descriptor 617 from storage 244. The TEE container 332 and the TEE provisioning proxy 242 share the same TEE identity and exist in the same root of trust domain. This enables the TEE container 332 to unseal the ML Engine package descriptor 502 structure. The TEE container 332 then unseals 618 the descriptor 617. The descriptor 502 is used to verify the ML engine 106 and which may then be executed.

Embodiments provide a token-bound remote attestation provisioning mechanism for securely provisioning user data into the ML-TEE. The provisioning mechanism validates the security state of hardware-backed TEE prior to sensitive data being transmitted between the user and an application backend executing in a TEE.

Remote attestation is a method by which a client or user authenticates its hardware and software configuration to a remote server. The goal of remote attestation is to enable a remote system to determine a level of trust in the integrity of a computing platform of another system. Remote attestation can also be used as a method to provision secrets to a remote computer system whose integrity of platform has been verified by the client or user wanting to share sensitive data. However, remote attestation on its own is insufficient for authentication of the identity of a user, or for authorizing that same user to provision secrets to a remote system.

To implement token-bound remote attestation, embodiments utilize an expanded sigma protocol to provide an identity and access management (IAM), time-limited token that is issued in response to a user request. By way of generalized introduction, IAM are one or more software functions or services that define and manage of roles and privileges of entities and users in the system and any restrictions on how users are granted (or denied) those privileges. A sigma protocol is a type of cryptographic “proof of knowledge” used to attest that a computer system “knows” something without necessarily having to provide that knowledge. Sigma protocols are characterized in that they include three steps: commitment, challenge, and response. The commitment is a first message from the user to the system to be verified. The challenge is a random challenge from the system to be verified. The response is a second message from the user.

When the provisioning server performs the remote attestation method, it will explicitly validate the access token and its policy to ensure it has not expired and that it was sent by the user who requested the token. Upon successful completion of the protocol, the provisioning server will be able to confidently bind the provisioned sensitive data to the identity of the user knowing they were authorized by a trusted system.

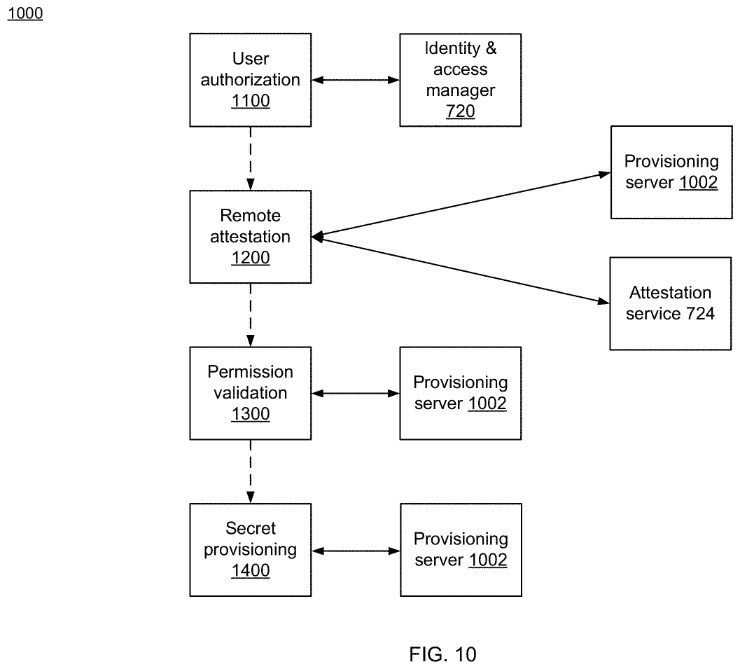

FIG. 10 illustrates an overview of a method 1000 for authenticated and authorized remote attestation (A2RA) via IAM token binding, according to an embodiment. In the method, a provider of personally identifiable information (PII) data 110 generates a long-term encryption key. The long-term encryption key is stored into a TEE secure element locally. The encryption key is provisioned into a secrets provisioning server via a secrets packager using a remote attestation procedure. The secrets provisioning server binds the encryption to the data provider's identity and wraps it with a DB encryption key. The secrets provisioning server provisions a DB of data provider encryptions keys to authorized ML-TEE containers. The data provider may then encrypt PII data with stored encryption keys prior to the data being sent to a ML-TEE container. The ML-TEE container may then decrypt and process user data. Throughout the method, plaintext data is never exposed outside of a TEE protected environment.

Method 1000 provides strong authentication and access control backed by an IAM system and corresponding IAM tokens which provides advantages over methods that only use certificate-based authentication. The authenticated and authorized remote attestation (A2RA) protocol is strongly bound to IAM generated tokens and a limited time window for secure provisioning governed and enforced by IAM token expiry, validity, and access control provides increased security.

As illustrated in FIG. 10, the method for token-bound remote attestation 1000 can be divided into four phases:
User authentication and authorization 1100
Remote attestation 1200
Token validation 1300
Secret provisioning 1400

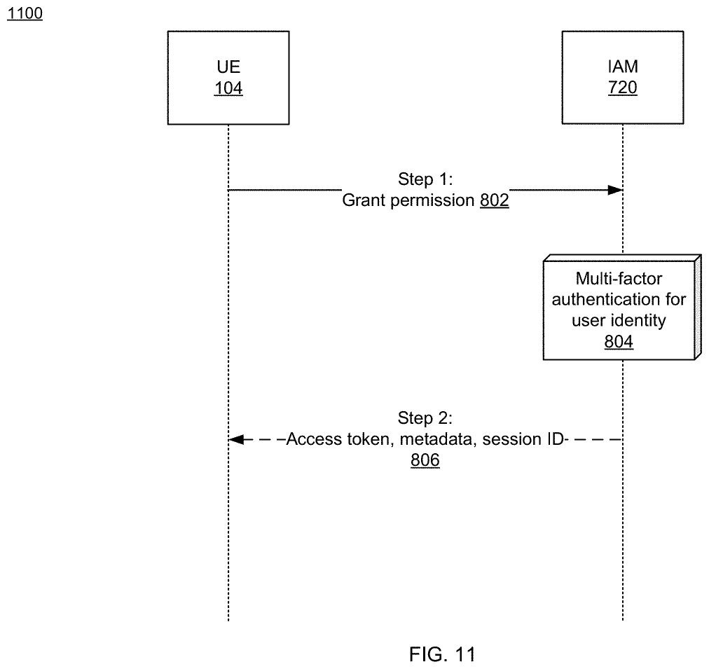

The user authentication and authorization 1100 phase is illustrated in FIG. 11. The protocol assumes a secure and private connection between the user equipment and the IAM 720, with network communications protected by TLS or an equivalent protocol. The UE 104 is assumed to have the IAM's 720 certificate in their trust store through prior provisioning of the UE 104. The trust store is used to securely store security credentials within the UE 104 and helps to determines what the UE 104 can trust when connecting to external network devices or validating signed messages or data.

In order to perform authentication, in step 1 the UE 104 (referred to as ‘A’) transmits a grant permission request 802 to the IAM 720. In some embodiments, the grant permission request 802 includes a public key of the UE 104, and a provision key, however other alternatives may be used. In response to receiving the grant permission request 802, the IAM 720 initiates a multi-factor authentication (MFA) process 804 to authenticate the UE 104. The MFA process 804 may prompt the UE user to enter their password in conjunction with an additional factor as specified by the MFA 804 process. This additional factor may include biometric data, an alphanumeric token, a SMS code, or other credentials, as defined by the MFA process 804.

Upon successful authentication and authorization of the grant permission request 802, in step 2 the IAM 720 sends back a response 806 including a token, t, access token metadata, t_{DATA}, and a signature SIG_{IAM}(t, t_{DATA}, A). The token metadata may contain information regarding token expiry, a refresh token, and any other data determined by the IAM 720. All data sent back is signed with the IAM's certificate to generate a cryptographic proof of origin in the form of the signature, SIG_{IAM}(t, t_{DATA}, A). At this point in the process, the UE's public key, A, is bound to the token, t. Upon receiving this message 806, the UE 104 is able to validate the origin of the token, t and that it came from a legitimate, trusted source. The IAM 720 is a trusted device, and compromising it will break security of the token-bound remote attestation 1000 so embodiments must ensure the security of the IAM 720 using methods known in the art.

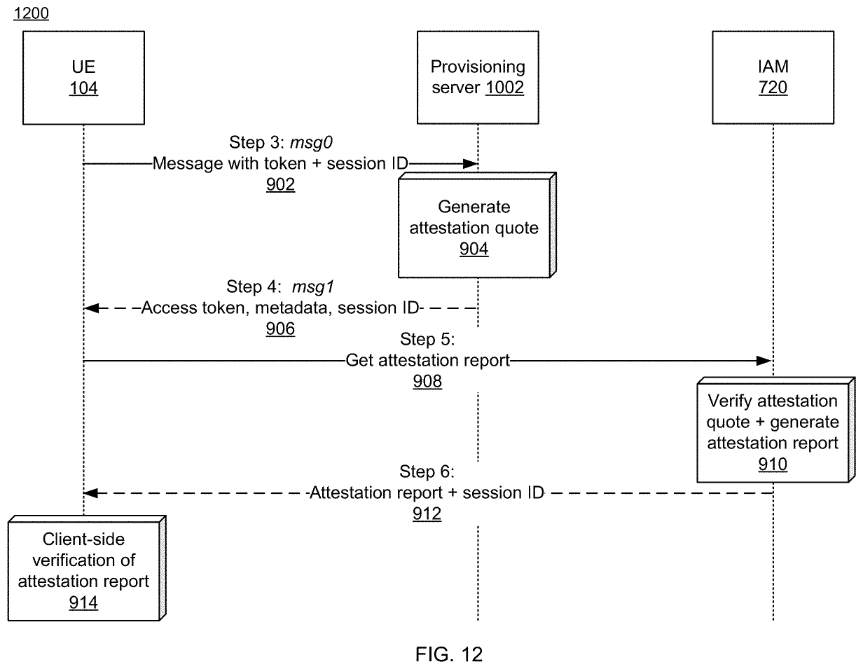

As illustrated in FIG. 12, embodiments include a remote attestation 1200 protocol that is performed after successful completion of the user authentication and authorization 1100 protocol. In some embodiments, the remote attestation 1200 protocol is an adaptation of a cryptographic SIGMA protocol. In particular, the SIGMA protocol may include additional provisions to ensure hardware authenticity and validation. SIGMA protocols are characterized in that they provide a secure key-exchange protocol based on the Diffie-Hellman key exchange (DHKE) to ensure “perfect forward secrecy”. Perfect forward secrecy is when even if a device's private key is compromised, session keys will not be. Unique session keys are generated based on events such as actions or messages, and the compromise of a single session key for that event will not affect any data other than that exchanged as part of that event.

In step 3, the UE 104 that was previously authenticated starts by transmitting a msg0 902 to a TEE-based application on provisioning server 1202 The message 902 may include parameters such as the access token and the signature, SIG_{IAM}(t, t_{DATA}, A) received in the response 806 of step 2. Message 902 may also include a new session ID, sid_{A}, a DHKE primitive, g^{x}, and a nonce, n_{A}. A DHKE primitive is a public value used in the exchange of keys. A nonce is an arbitrary number that is used only once as part of a cryptographic exchange.

In response to receiving msg0 902, the TEE application generates an attestation quote, q_{B}, 904 along with parameters session id, sid_{B}, DHKE primitive g^{y}, and nonce, n_{B}. The TEE-based application is also able to generate a shared seed. The shared seed is processed by a key derivation function (KDF) to generate the session encryption key, Kₑ, and session MAC key, Kₘ. In step 4, the TEE application then creates msg1 906, which includes the attestation quote, q_{B}, and sends it back to the UE 104. Msg1 906 includes an access token, the attestation quote, and H(q_{B}). Msg1 906 may also include session IDs for the UE 104 and IAM 720.

When the UE 104 receives msg1 906, the UE 104 may use the DHKE primitive to independently generate the shared seed to use as an input to its own KDF to generate a session encryption key, Kₑ, and a session MAC key, Kₘ. This allows the UE 104 to decrypt and extract the attestation quote, q_{B} from msg1 response 906. In step 5, the UE 104 may transmit a request for the attestation report, q_{B}, 908 (in a GetAttestationReport message) to an attestation service that is part of the IAM 720 or an external hardware vendor.

In step 6, the attestation service of the IAM 720 responds to the UE's 104 request 908 with the attestation report 912, r_{B}, its signature SIG_{AS(rB)}, and the session ID. The UE 104 is able to validate 914 the attestation report signature to affirm that it came from a trusted source, that the attributes of the attestation report match those of the TEE, and that the TEE is in a secure state.

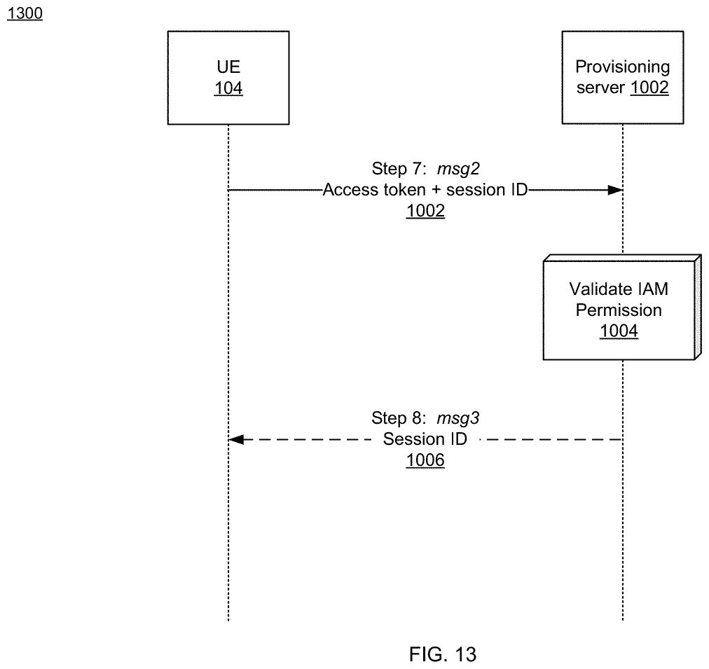

FIG. 13 illustrates permission validation 1300 protocol which may be performed after the successful completion of the remote attestation 1200 protocol. The permission validation 1300 protocol allows for the UE 104 to present the IAM-generated access token to the TEE-based application for final authorization to execute the operation for the requested permissions. In step 7 the UE 104 sends msg2 1002 including the token, t, that the UE 104 received from the IAM 720 in response 806, to the TEE-based application for final authorization to receive the requested permission. The UE 104 encrypts the token, token metadata, H(q_{B}), and the cryptographic proof of origin, and other parameters defined in the attestation report 912 and sends them to the TEE-based application. By doing so, the UE 104 binds its identity to the IAM-generated access token presented by the UE 104 in order to show the TEE-based application that the UE 104 is in fact the owner of the token, t, received in step 2 806.

Upon receiving the access token from the UE 104 in msg2 1002, the TEE-based application will verify 1004 the IAM-generated access token. The verification process 1004 consists of verifying the signature of the token, ensuring the token is still valid, and verifying the UE 104 signature across the parameters of msg2. If everything passes, the TEE-based application will sign the signature, SIG_{IAM}(t, t_{DATA}, A) received in response 806, along with the other parameters as proof of successful verification of the UE's 104 token. In step 8, the session ID is then returned to the UE 104 in msg3 1006.

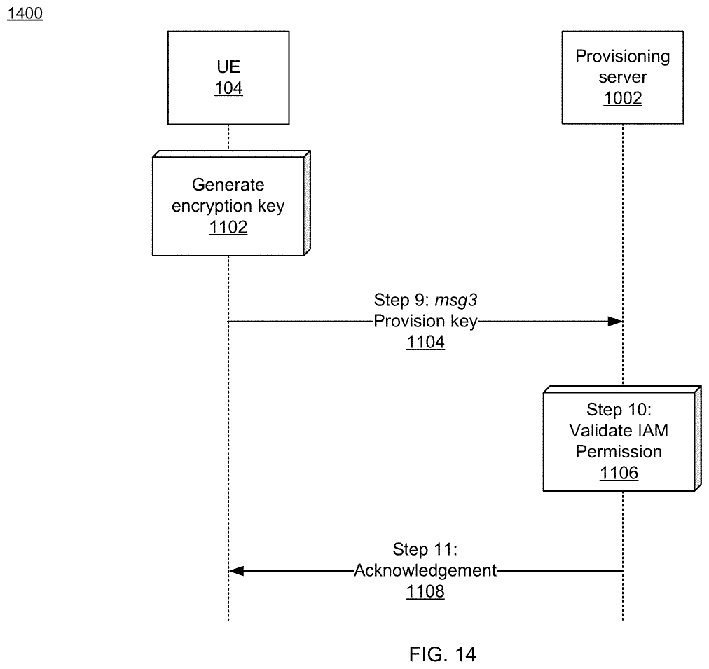

FIG. 14 illustrated a secrets provisioning 1400 protocol where the UE 104 generates and packages their secret data to be provisioned in the TEE-based application by the provisioning server 1002. The secret data is encrypted with the session encryption key, Kₑ, and the receiving TEE validates the secret data against the time-limited token, t. As way of generalized introduction, a TEE, which is a hardware secured area of a computer processor or computer system, may perform validation, that is to verify the correctness of (secret) data that is qualified by a token that will expire after a period of time. Performing validation within the TEE ensures that the software code and data may be protected with respect to confidentiality and integrity and by utilizing a time-limited token ensures that the validation must be performed within a predetermined period of time.

Upon receiving msg3 1006, in step 9 the UE 104 proceeds to prepare the secret data, A_{KEY}. A_{KEY} along with the permission verification proof SIG_{B}(n_{A}, sid_{B}, SIG_{IAM}(t, t_{DATA}, A)) are all signed by the UE 104 and inserted into the Provision Key message 1104.

When the TEE-based application receives the Provision Key message 1104, it decrypts it using the session encryption key Kₑ. It proceeds to verify that the message arrived with proof of the permission verification, and that it arrived within a time period in which the token is valid. At that point, the TEE-based application is able to trust that A_{KEY} was generated by the UE 104, that the token, t, is owned by the UE 104, and that permission was granted to the UE 104 for the ProvisionKey operation.

In step 11 an acknowledgement 1108 is sent back to the UE 104 once the secret has been successfully provisioned into the TEE-based application.

Embodiments using token-bound remote attestation 1000 provide authentication and identity protection. Embodiments utilize IAM components that adds identity-checks through multi-factor authentication (MFA). UEs are able to request IAM generated access tokens to receive access permissions. The administrator of the IAM can generate policies and permissions based on the IAM's needs, independent of the token-bound remote attestation 1000 protocols. The token-bound remote attestation 1000 protocols cryptographically validate that the generated access token was signed by the IAM and defer to the application's backend service running in the TEE to enforce permissions and policies.

Token-bound remote attestation 1000 protocols are independent of hardware attribute attestation or hardware security state. Token-bound remote attestation 1000 protocols rely on the hardware being genuine, the hardware's drivers being up-to-date, the hardware's security state being up-to-date, and that the application's backend service TEE is signed by a key trusted by the hardware. Token-bound remote attestation 1000 protocols add to hardware attestation by inserting additional message flows so that the TEE generates and registers a quote with the hardware vendor's attestation service that may be cryptographically verified. It also allows for the attestation service to sign an attestation report vouching that the hardware attributes of the TEE could have only been generated on genuine hardware. The UE 104 is able to receive an attestation report independently, verify its signature and contents before proceeding with presenting its IAM-generated access token. This protects against accidental leakage in cases where the hardware is not in a valid state. In addition, if the attestation service supports revocation lists, then the UE can request those as well to ensure that the attestation report for a given TEE has not been revoked due to an operational security issue unrelated to the token-bound remote attestation 1000 protocol.

Token-bound remote attestation 1000 protocols may include policy metadata for the IAM generated access token of which one of the attributes is the time period during which the access token is valid and useable for attestation. Should the access token expire, the Token-bound remote attestation 1000 protocol can be configured to fail by introducing additional validity checks of the access token based on corresponding policy metadata. By time-limiting the validity of the access token, the token-bound remote attestation 1000 protocol introduces additional mechanisms that reduce the attack surface for threats that replay or spoof messages from a SIGMA protocol based exchange between clients and servers. Once the token is used in a successful provisioning, it may be invalidated by the backend service in conjunction with the IAM even if its validity period has not expired.

As used herein, the terms “about” and “approximately” should be read as including variation from the nominal value, for example, a ±10% variation from the nominal value. It is to be understood that such a variation is always included in a given value provided herein, whether or not it is specifically referred to.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for executing a machine learning (ML) application in a computing environment, the method comprising:
receiving, from a trusted execution environment (TEE) of a user computing device, into a TEE of a server, a secret, the user computing device being authenticated by an identity and access management (IAM) service, the TEE validating the secret against a time-limited token;
receiving, from a TEE of a model release tool, into the TEE of the server, a model encryption key (MEK) bound to the ML application;
receiving, from the TEE of the ML model release tool, into the TEE of the server, an ML model of the ML applications, the ML model encrypted with the MEK;
decrypting using the MEK, by the TEE of the server, the ML model;
receiving, from a TEE of a provisioning server, into the TEE of the server, the ML application and a descriptor of the ML application, the descriptor encrypted by a cryptographic key derived from the secret; and
executing the ML application using the ML model and the descriptor.

2. The method of claim 1 wherein the ML model is contained within an ML volume, the ML model encrypted with the MEK.

3. The method of claim 2 wherein the MEK is tied to a user ID of an owner of the ML model and a hash is used to verify the integrity of the ML volume.

4. The method of claim 1 wherein the time-limited token is bound to a cryptographic key of the user computing device.

5. The method of claim 1 further comprising:
sending, by the user computing device, an attestation quote request to the server, the attestation quote request including the time-limited token;
receiving, by the user computing device, an attestation quote from the server, the attestation quote based on the TEE of the server;
sending, by the user computing device, an attestation report request for an attestation report to an attestation service, the attestation report request including the attestation quote and the access token;
receiving, by the user computing device, the attestation report, the user computing device validating the attestation report.

6. The method of claim 1 wherein the MEK is bound to the ML application.

7. The method of claim 1 further comprising:
storing, by the server, the ML model in a model registry, the ML model being sealed in the model registry;
receiving, by an ML-TEE, the ML model from the model registry, and unsealing the ML model.

8. The method of claim 1 further comprising:
the server sealing the ML application descriptor using a cryptographic key derived from the secret, the server sending the ML application descriptor over a secure channel between TEE of a provisioning server and the TEE of the server, the TEE of the server independently deriving the cryptographic key derived from the secret stored therein.

9. The method of claim 1 wherein the ML application includes an ML engine and non-confidential data, the ML application being executed on the ML engine using the non-confidential data.

10. A system for executing a machine learning (ML) application in a computing environment, the system comprising a plurality of computing devices, each of the computing devices including a processor and a non-transient memory for storing instructions which when executed by the processor cause the system to:
receive, from a trusted execution environment (TEE) of a user computing device, into a TEE of a server, a secret, the user computing device being authenticated by an identity and access management (IAM) service, the TEE validating the secret against a time-limited token;
receive, from a TEE of a model release tool, into the TEE of the server, a model encryption key (MEK) bound to the ML application;
receive, from the TEE of the ML model release tool, into the TEE of the server, an ML model of the ML applications, the ML model encrypted with the MEK;
decrypt using the MEK, by the TEE of the server, the ML model;
receive, from a TEE of a provisioning server, into the TEE of the server, the ML application and a descriptor of the ML application, the descriptor encrypted by a cryptographic key derived from the secret; and
execute the ML application using the ML model and the descriptor.

11. The system of claim 10 wherein the ML model is contained within an ML volume, the ML model encrypted with the MEK.

12. The system of claim 11 wherein the MEK is tied to a user ID of an owner of the ML model and a hash is used to verify the integrity of the ML volume.

13. The system of claim 10 wherein the time-limited token is bound to a cryptographic key of the user computing device.

14. The system of claim 10 wherein the system further caused to:
send, by the user computing device, an attestation quote request to the server, the attestation quote request including the time-limited token;
receive, by the user computing device, an attestation quote from the server, the attestation quote based on the TEE of the server;
send, by the user computing device, an attestation report request for an attestation report to an attestation service, the attestation report request including the attestation quote and the access token;
receive, by the user computing device, the attestation report, the user computing device validating the attestation report.

15. The system of claim 10 wherein the MEK is bound to the ML application.

16. The system of claim 10 wherein the system further caused to:
store, by the server, the ML model in a model registry, the ML model being sealed in the model registry;
receive, by an ML-TEE, the ML model from the model registry, and unsealing the ML model.

17. The system of claim 10 wherein the system further caused to:
seal, by the server, the ML application descriptor using a cryptographic key derived from the secret, the server sending the ML application descriptor over a secure channel between TEE of a provisioning server and the TEE of the server, the TEE of the server independently deriving the cryptographic key derived from the secret stored therein.

18. The system of claim 10 wherein the ML application includes an ML engine and non-confidential data, the ML application being executed on the ML engine using the non-confidential data.
